(19) United States
(12) Patent Application Publication
(10) Pub. No.: US 2025/0058253 A1
(43) Pub. Date: Feb. 20, 2025

(54) FILTER ELEMENT

(71) Applicant: Robert Bosch GmbH, Stuttgart (DE)

(72) Inventors: Jan Semet, Vordersteinenberg (DE); Javier Fernandez Garcia, Getafe (ES); Jose Luis Arias Arias, Madrid (ES); Ruben Schreiber, Ludwigsburg (DE)

(21) Appl. No.: 18/721,538

(22) PCT Filed: Dec. 19, 2022
(86) PCT No.: PCT/EP2022/086668

§ 371 Date: Aug. 19, 2024

(30) Foreign Application Priority Data
Dec. 20, 2021 (DE) 10 2021 214 647.3

(51) Int. Cl. B01D 29/13; B01D 35/30

(52) U.S. Cl. CPC B01D 29/13; B01D 35/30; B01D 2201/291; B01D 2201/347

(57) ABSTRACT

Filter element for filtering a liquid, wherein the filter element (1) is designed to be installed in a housing (31) with a cover (32), the filter element (1) having a first end cap (2) facing the cover (32), a second end cap (3), and a filtering medium (4) with a hollow interior (5), wherein the filter medium (4) is arranged between the first end cap (2) and the second end cap (3), wherein the first end cap (2) has a sealing means (6) over the outer circumference of the end cap, wherein the first end cap (2) has a first opening (7), wherein an elastically reversible compensation element (8) can be arranged in the interior (5), said compensation element in a position of a cover-side exterior (9) of the filter element (1) arranged in the interior (5) protrudes into the interior (5) through the first opening (7) and seals the interior (5) in a fluid-tight manner against a passage of liquid from the interior (5) into the cover-side exterior (9) through the first opening (7), wherein the sealing means (6) is designed to seal off an outer filter volume (11), which is positioned between a housing wall (33), an outer side (10) of the filter medium (4), and a lower side (21) of the first end cap (2), said lower side facing the filter medium (4), from the cover-side exterior (9) when the filter element (1) is installed in the housing (31).

### BACKGROUND

The invention relates to a filter element designed for filtering a liquid and designed for the installation parallel to an axial direction in a housing with a cover. The invention also relates to a filter element for use in a DENOX liquid filter. The invention also relates to a liquid filter with such a filter element.

Liquid filters, for example for fuels or aqueous solutions, are known from the prior art. Such aqueous solutions can be, for example, urea solutions for use in SCR systems (“selective catalytic reduction”) in exhaust gas aftertreatment systems of motor vehicles (in this case, such a liquid filter can be a DENOX liquid filter). It is also known that the liquids to be filtered by the liquid filter can freeze or gel at low ambient temperatures. Especially in the case of filters for aqueous solutions, freezing can occur at relatively high temperatures compared to the gelling of diesel fuel or gasoline. Furthermore, filters for SCR systems are often installed in exposed areas of a vehicle, making it particularly easy for cold to attack them. In particular, the cover of such a (DENOX) liquid filter can be directly exposed to an external environment in which the air can move convectively or even the airstream can attack the cover and in this way the cover represents a constant heat sink at low temperatures. Such covers are usually made of plastic or metal and therefore also have a relatively high temperature coefficient, which is approx. 0.23 W/K*m for PA66 (glass fiber-filled polyamide), for example. Such filters often have a so-called compensation element, which is designed to be elastically reversible and is elastically reversibly compressed when ice starts to form. In this way, the housing of the liquid filter is protected against damage caused by ice pressure. In conventional filters for aqueous solutions, the liquid on the unfiltered side or on the filtered side of the filter element usually reaches an exterior on the cover side of the filter element, which is located between a housing cover and a first end cap of the filter element. In this way, the liquid comes particularly close to the external environment of the liquid filter or even in direct contact with the cover. Or it is only separated by a thin solid layer, for example a wall of the compensation element, from an inner wall of the cover or a support element held by the cover, which is in contact with the external environment of the liquid filter and thus represents a heat sink via convection, wherein the material of the compensation element, e.g. rubber, also has a fairly high temperature coefficient (rubber, for example, approx. 0.16 W/K*m) and the material thickness is also quite thin for cost reasons and in order not to impair the deformability.

In the case of liquid filters, a so-called internal seal within a liquid filter, which prevents a fluidic short circuit between a filtered side and an unfiltered side of the filter element, must also be ensured. At the same time, a so-called external seal must also be ensured, which prevents leakage of liquid from the inside of the liquid filter into an external environment of the liquid filter. It is known from the prior art that the internal and/or external sealing is effected by sealing elements which are arranged on the cover of the filter housing and/or which effect the sealing as an axial seal by interacting with the cover of the filter housing. In the latter case, the seal is created by axially compressing a sealing means (i.e. compressing the sealing means along the axial direction that results, for example, from the direction of installation of a filter element in the housing) between the cover and a corresponding mating element of the filter element or the filter housing with the sealing means interposed.

DE 10 2012 223 028 A1 discloses such a liquid filter with a filter element and a compensation element which is inserted into the interior of a filter element. Both the internal sealing and the external sealing take place along the axial direction. For the external seal, an elastically reversible protective cover, which acts as a compensation element, is clamped in a sealing area between the cover and the rest of the housing along the axial direction. Furthermore, it is provided that during normal operation of the liquid filter, the fluid system pressure ensures that liquid from an interior of the filter element passes through an opening in an end cap of the filter element and is only separated from an external environment of the liquid filter by a second area of the protective cover.

DE 10 2016 005 659 A1 discloses another liquid filter with a compensation element that projects into an interior of a filter element. The internal seal is achieved by applying a force acting in the axial direction through the cover onto the filter element with an intermediate layer of sealing means. The external seal is provided by a seal running around the outer side of the cover. Furthermore, it is intended that liquid from the interior of the filter element reaches the cover of the liquid filter and that liquid from the outer side of the filter element also reaches the lower side of the cover facing the filter element. The core idea of this document is to allow the liquid inside the liquid filter to freeze as quickly and evenly as possible on the outer wall of the compensation element at very low outside temperatures, which is why the best possible connection of the hollow interior of the compensation element to the cold ambient air of the external environment of the liquid filter is provided.

### SUMMARY

It has been shown that for safe operation of such liquid filters, heating elements or other means are required even at low temperatures in order to quickly thaw or liquefy frozen or gelled liquid during or after starting the motor vehicle and/or to keep the liquid in a liquid aggregate state at low outside temperatures during operation of the motor vehicle or machine.

Thawing larger quantities of liquid that is in a frozen or gelled state inside the filter element or liquid filter and/or keeping such liquids liquid requires larger amounts of energy, usually electrical energy, which must be drawn from a battery or an on-board power supply system of the motor vehicle, which leads to increased fuel consumption and a poorer CO2 balance. Furthermore, it has been shown that contamination of the inner side of a filter medium with dirt, grime and/or lubricants, e.g. during maintenance work or replacement of the filter element, can lead to an undesirable inhomogeneous heat flow in the interior of the filter element, which means that the heating energy supplied must be additionally increased in order to make all areas of the interior reliably ready for operation. Furthermore, it has been shown that the greater the volume of liquid in the filter element, the greater the amount of heating energy required to thaw or keep the liquid in the filter element liquid. Finally, it has been shown that the risk of internal leakage (i.e. a fluidic short circuit between the unfiltered side and the filtered side) as well as the risk of external leakage (i.e. leakage of liquid from the interior of the housing into the external environment of the liquid filter) can depend on the temperature exposure of the sealing means and/or the temperature gradient across the sealing means.

Furthermore, it has been shown that the design of the internal and/or external seal as an axial seal can be prone to faults during maintenance work, e.g. after the initial fitting of the liquid filter, for example to replace the filter element. In the case of axial seals, the quality of the sealing effect can also depend on the cover being fitted correctly and not, for example, tilted on or in the filter housing. Tilting can, for example, lead to uneven pressure on the sealing means or the axial seal along a circumferential direction running around the axial direction, so that individual points along the circumferential direction of the axial seal are less compressed than others and a leakage path can therefore occur at these points. Furthermore, the quality of the sealing effect can also depend on the force with which the cover acts on the sealing means along the axial direction. It can therefore be necessary to maintain a precisely defined torque for screw caps, for example. Excessive torque can lead to the sealing means being crushed. Too little torque can lead to an insufficiently formed sealing section and thus to a leakage path. Furthermore, it has been shown that the arrangement of sealing means for the external seal on the cover itself means increased effort during pre-assembly, as the sealant must be arranged correctly on the cover and this represents an additional work step during pre-assembly. Furthermore, the force required to mount the cover is relatively high with such sealing means arranged on the cover, for example around the cover, which makes the installation uncomfortable. Friction can cause the cover to tilt during installation. Furthermore, when setting a required torque, the friction of the seal on the cover can lead to incorrect measurements in such a way that the torque corresponds to the specified value, but the force imparted by the torque acts to a greater extent than intended in the seal of the cover and thus the actually intended force exerted along the axial direction to create an axial seal within the liquid filter is not achieved at all. Finally (as already explained above), such sealing elements, which are installed directly on the cover, can be susceptible to premature embrittlement in the case of strongly changing temperatures in the external environment of the liquid filter, so that the sealing effect can diminish earlier than intended.

There can therefore be a need to provide a filter element in which both the internal seal and the external seal can be achieved securely, reliably and permanently by simple means. It should also be easy to install and robust against fluctuations in the quality of installation work with regard to the sealing effect. Furthermore, the sealing means should be exposed to the lowest possible temperature gradients and be as well protected as possible against strong temperature fluctuations.

At the same time, there can be a need to provide a filter element for a liquid filter which prevents the liquid from freezing quickly at low outside temperatures for as long as possible and/or which is designed to use the energy supplied by a heating element as efficiently as possible. In other words: The amount of energy required to thaw frozen or gelled liquid in the liquid filter or filter element should be kept as low as possible and the amount of energy required to keep the liquid in the liquid filter or filter element in a liquid state of aggregation at low outside temperatures should also be kept as low as possible. At the same time, there can also be a need to prevent contamination of the inner side of the filter medium in order to minimize the amount of energy required to thaw the frozen or gelled liquid evenly at low temperatures.

According to a first aspect of the invention, a filter element is proposed.

The filter element is designed to filter a liquid. It is also designed for the installation parallel to an axial direction (e.g. along the axial direction or against the axial direction) in a housing with a cover. In particular, this can be a housing and a cover of a liquid filter, for example a DENOX filter or DENOX liquid filter, which can be used in an SCR system, for example. The filter element has: a first end cap (when the filter element is installed in the housing) facing the cover, a second end cap (when the filter element is installed in the housing) facing away from the cover, and a filter medium with a hollow interior. The filter medium is arranged along the axial direction between the first end cap and the second end cap, wherein a radial direction runs perpendicular to the axial direction (and, for example, a circumferential direction runs around the axial direction). The first end cap has a sealing means over the outer circumference, wherein the first end cap has a first opening, wherein an elastically reversible compensation element can be arranged in the interior, which in a state arranged in the interior projects from a cover-side exterior of the filter element through the first opening into the interior. In a state arranged in the interior, the compensation element seals the interior in a fluid-tight manner against the passage of liquid from the interior into the cover-side exterior space through the first opening. When the filter element is installed in the housing, the sealing means is designed to seal a filter outer volume located between a housing wall, an outer side of the filter medium and a lower side of the first end cap facing the filter medium against the exterior on the cover side.

This has the advantage that both the external seal and the internal seal in the cover-side area of the filter element are created solely by the filter element or by sealing means arranged on the filter element, and direct cooperation from the cover is not required. In other words: Even the filter element installed in the housing (without the cover being installed at all) could be operated safely in this way without liquid from the inside of the housing getting into an external environment of the liquid filter and without a fluidic short circuit occurring between the unfiltered side and the filtered side. The cover is therefore advantageously only required to securely and permanently fix the filter element in the housing. It therefore does not have to be involved in the fluidic sealing of the liquid to be filtered, wherein a further seal is not excluded as a redundancy of the external seal. In addition to the fixing effect of the filter element in the housing, it also acts as protection against the penetration of dirt, grime or liquids, such as splash water from the external environment, into the housing. The filter element designed in this way is therefore autonomous in terms of its sealing effect. This makes it particularly easy to carry out a quality check on the sealing effect during pre-assembly of just the filter element. Separate pre-assembly of sealing means on the cover and/or quality testing of such a seal can be dispensed with. This makes the manufacturing process more cost-effective. Another advantage is that the installation of the filter element is simplified during maintenance, as a fitter only has to check the filter element and its sealing means and does not have to additionally check a sealing means located on the cover. Another advantage is that it is not necessary to maintain a very precise torque or axial force on the cover when installing the cover. Another advantage of this method is that it ensures that the sealing means for external sealing (on the first end cap) and also the internal sealing by means of the compensation element are arranged at a clear distance from the external environment and are therefore not directly exposed to strong temperature fluctuations and that the temperature gradient in the sealing means or along the sealing section can also be lower than would be the case with an installation closer to the cap.

Furthermore, this advantageously ensures that no liquid is present between an upper side of the first end cap facing the cover and the cover. This prevents the direct transfer of cold from the cover to the liquid and also to the sealing means. In other words, the liquid is advantageously spaced over a greater distance from the cover, which acts as a heat sink. The liquid is also advantageously separated from the cover for the most part at least by the first end cap. All this has the advantage of reducing cooling of the liquid or heat loss from the liquid to the external environment. This has the advantage that the liquid in the filter element or the liquid in the filter outer volume below the first end cap only freezes after a longer period of time compared to a situation in which the liquid is located in the cover-side exterior-it also takes longer for crystallization points to form in the liquid, which initiate the freezing process. In this way, the energy required to thaw or prevent a liquid in the filter element from freezing is also advantageously reduced. This is because the energy used no longer has to be used to heat the liquid in direct or indirect contact with the cover against the cold acting inwards from the cover or to dissipate valuable thermal energy to the heat sink of the cover or the external environment. In other words: A type of thermal insulation is created that prevents a cold bridge from an external environment of the filter element or the liquid filter directly into the liquid-filled cover-side exterior.

It can also be provided, for example, that the interior of the compensation element is separated from the external environment of the liquid filter by separating means in such a way that although air can be exchanged with the external environment during compression or decompression of the compensation element, air convection or open air exchange between the interior of the compensation element and the external environment is prevented at the same time. For this purpose, only the following can be provided as separating means, for example: a cap element in or on the cover or a sealing cap (e.g. as a pressure equalization element), e.g. for clipping into the first opening, a membrane (this can also be part of the cap element), in particular a membrane which is permeable to gases but impermeable to moisture, a labyrinth seal or an interdigital structure at least in a section of the compensation element, in which projections project from two or more inner sides into the interior of the compensation element, which are offset from one another along the axial direction, so that gas exchange with the external environment is suppressed or slowed down. Other release agents with an equivalent effect are also conceivable. It is also conceivable that the compensation element is manufactured and/or filled from a compressible material, e.g. a foam, so that the interior of the compensation element is filled with this material. In this way, a cold bridge from the external environment into the interior of the filter element is prevented, as non-circulating air or air that is not subject to convection has a very low thermal conductivity of approx. 0.026 W/K*m.

In a further development, it is provided that the sealing means is designed for sealing along the radial direction, wherein the sealing of the first opening by the compensation element is designed as a seal along the radial direction. This has the advantage that the external seal is created immediately when the filter element is installed in the housing, e.g. when the filter element is inserted into the housing. The sealing effect of the internal seal is achieved when the compensation element is installed in the filter element. Advantageously, the cooperation of the cover can therefore no longer be required for the sealing effect. In particular, it is not necessary for a fitter to use precisely defined forces or torques to attach the cover to or in the housing, for example by screwing it in. This is an advantageous way of avoiding installation errors, which could impair the filtration effect due to a fluidic short circuit between the unfiltered side and the filtered side or allow liquid to escape from the liquid filter into the external environment.

In a further development, it is provided that the compensation element has a body with a wall projecting into the interior, wherein the wall has a thickened section with a thickening in the region of the first opening. The seal between the compensation element and the first opening can be formed in the thickened section, for example. This has the advantage that the sealing effect of the compensation element against an edge of the first opening is particularly reliable and secure. The internal seal or gasket is therefore particularly reliable. The thickening can be used, for example, to compensate for manufacturing tolerances in the diameter of the first opening or in the outer diameter of the compensation element. Furthermore, temperature-related changes in the volume of the wall of the compensation element or the diameter of the first opening can be compensated for. This improves the sealing effect permanently and in all possible operating conditions.

In a further development, it is provided that the thickening of the wall in the thickened section is formed both inwards and outwards when viewed in the radial direction. This has the advantage of further improving the sealing effect. The compensation element is also easier to manufacture and install. The thickening can be designed in the form of an O-ring formed in one piece with the compensation element.

In a further development, it is provided that the thickening is at least 1 mm, preferably at least 2 mm. For example, it can be necessary to compare the thickness at the point of thickening with an average wall thickness of the wall. For example, the average wall thickness in the vicinity of the thickening can be used. Possible additional elements, such as latching lugs or similar, which have a specific function, can be disregarded when determining the average wall thickness.

This has the advantage that a sufficiently high tolerance compensation for fluctuations due to temperature or production fluctuations is available and the sealing effect of the compensation element in the thickened section is always ensured.

In a further development, it is provided that the compensation element has (at least one) latching lug on its outer side, wherein the compensation element has (at least one) radial section which is spaced apart from the latching lug in the axial direction and extends radially outwards, wherein the compensation element is held in the first opening by means of the latching lug and the radial section. The latching lug can, for example, be formed all the way around the compensation element. However, it can also be formed only in sections around the outer side of the compensation element, so that there is only a single latching lug or several latching lugs. In the same way, the radial section can, for example, run around the compensation element in a closed loop. However, it can also be formed only in sections, so that there is only a single radial section or several radial sections. The compensation element can be held in place by means of a latching lug and radial section, for example, in the form of a button-in, so that the compensation element is buttoned into the first opening by means of the latching lug and the radial section. Retention can be achieved, for example, by an edge of the first opening coming to rest between the latching lug(s) and radial section(s) as viewed along the axial direction and being held in this way by the latching lug(s) and radial section(s), which act as undercuts. For example, it can be provided that the axial spacing of the latching lug and the radial section has an extension which is in a range between 80% and 120% of a thickness of the first opening at its edge, which is arranged between the latching lug and the radial section. In this way, the edge of the first opening can be clamped between the latching lug and the radial section. However, it can also be necessary to allow a certain amount of play along the axial direction in order to absorb or compensate for thermal stresses or tensions caused by the effect of ice pressure on the compensation element. It can be provided that the thickened section is arranged between the latching lug and the radial section when viewed in the axial direction.

The (at least one) latching lug has the advantage that the compensation element can be securely and reliably installed in or on the filter element. A fitter can easily recognize when the installation has been successful by receiving haptic feedback (the inserted compensation element locks into place at the edge of the first opening and cannot be easily pulled out again). In this way, the sealing of the compensation element to the first opening is also formed securely and reliably. Another advantage is that the compensation element is held securely in the first opening in this way and cannot easily slip out of the first opening during overhead installation, for example, and thus lose its sealing effect.

In a further development, it is provided that in a state of the filter element installed in the housing, the compensation element is clamped between the first opening and a collar element projecting from the cover into the first opening when viewed in the radial direction.

This advantageously ensures that the first opening is sealed inside or on the inner side of the first opening. A radial sealing effect is achieved in a simple manner, which is independent of the axial pressure or axial force of the cover. In this way, a greater sealing distance can be advantageously achieved. Another advantage of this method is that the pressure of the liquid acting in the axial direction can be redirected in the radial direction, which results in less pressure load on the cover. Another advantage of this method is that the sealing effect can already be achieved and tested when the compensation element is installed on or in the filter element, as it is not dependent on an axial position and/or axial pressure of the cover on the compensation element as a seal. In this way, the sealing effect can also be advantageously checked after the compensation element has been installed and the risk of leakage due to, for example, an incorrectly installed cover (e.g. too little torque applied to the cover) is advantageously completely eliminated in this way. In other words: the correct replacement of filter elements, e.g. during maintenance work, is made easier and more reliable. The clamping by the collar element primarily prevents the sealing section between the compensation element (or its outer side) and the edge of the first opening from loosening.

In a further development, an end cap element projecting in the axial direction towards the cover is provided on the first end cap. The end cap element can, for example, be designed as a first connecting piece. When the filter element is installed in the housing, the compensation element is clamped between the end cap element and a collar element projecting from the cover into the first opening when viewed in the radial direction. The end cap element has the first opening or, viewed from the outside, the first opening is assigned to the end cap element.

The same advantages arise as above for clamping the compensation element between the first opening and the collar element. Furthermore, the end cap element can advantageously create a greater distance between the end cap (or its upper side) and the cover (or its lower side), which improves thermal insulation from the external environment. This thermal insulation enables lower temperature fluctuations and/or temperature gradients at the seals (sealing means or compensation element) for external and/or internal sealing. Another advantage is that heating energy can be used more efficiently to thaw frozen or gelled liquid or to maintain the liquid phase, thereby saving energy. Furthermore, the end cap element can also be used to produce simplified filter elements from the same second end cap and the same filter medium if the housing of different liquid filters has a different length. Only the first end cap and the end cap element need to be adapted. This makes it possible to adapt the length with little effort, which reduces part costs.

In a further development, the sealing means is designed as an O-ring or a sealing cord. This advantageously provides a particularly simple and cost-effective sealing means. Another advantage is that the sealing means can be easily adapted to diameters of the first end cap that vary depending on the filter element.

The fact that the sealing of the exterior on the cover side by means of the compensation element and the sealing means is designed in such a way that the cover is not in direct contact with the liquid at any point has the advantage that the liquid does not freeze so quickly when low temperatures are applied to the cover that are below the freezing point of the liquid. A direct cold bridge and the formation of crystallization nuclei for ice formation are prevented. Another advantage is that the heating energy supplied to the liquid is used much more effectively to thaw the liquid and/or keep it liquid. This means that the same volume of liquid or frozen liquid can be thawed or kept liquid with less energy input. Another advantage is that the temperature fluctuations at the external and/or internal seal are kept low, which extends the service life of the sealing means and/or compensation element.

In a further development, it is provided that in a state of the filter element installed in the housing, the first end cap is spaced from the cover by a gap over at least 50% of its area without the first opening, preferably over at least 70% of its area without the first opening. The gap is filled with air, for example. For example, it is filled exclusively with air along at least 50% of the surface area, preferably over at least 70% of the surface area of the first end cap, wherein the surface area percentage is based on the surface area of the first end cap without taking into account the surface area of the first opening. This creates a particularly safe, reliable and cost-effective insulation between the cover and the first end cap. Air is a very good insulator against cold, as the thermal conductivity of air is very low (approx. 0.026 W/K*m). The compensation element can also be designed more cost-effectively in this way. It is not necessary for the compensation element to have a radial section that extends over the surface of all or a large part of the first end cap. This allows the compensation element to be packaged more easily (it has a smaller form factor) and installed. It is also much cheaper to produce. Furthermore, air has a better insulation against cold than the material of the compensation element. In addition, the gap can have a greater height in the axial direction than the material thickness of the compensation element. This further increases the insulation effect. Furthermore, the external and/or internal seals are advantageously exposed to lower temperature fluctuations and/or temperature gradients in this way.

It is understood that there can be selective contact between the cover and the first end cap, e.g. to enable the first end cap to be attached to the cover or to enable coupling between the first end cap and the cover. For example, in order to be able to transfer rotational forces from the cover to the first filter element when installing the filter element in the housing of the liquid filter. However, these contacts are advantageously limited to small surface cross-sections so that the heat flow from the filter element to the cold cover (at low outside temperatures) is as low as possible.

The fact that the gap along the axial direction has an average thickness of at least 1 mm, preferably at least 2 mm, has the advantage that the insulating effect is particularly effective. It should be understood that the gap can have a thickness of less than 1 mm at individual points. Such locations are preferably present on less than 10% of the surface of the first end cap without the first opening.

The first opening is not included when calculating the area of the first end cap. For example, in the case of a round first end cap with a round first opening, the area of a circular ring is used as a reference value for the area percentage.

In a further development, it is provided that the second end cap has a second opening for liquid to flow through, wherein a grip guard is arranged in the second opening, which is designed to prevent a finger from penetrating into the interior through the second opening.

This advantageously prevents contamination of the inner side of the filter medium when the compensation element is installed in the interior, e.g. by a fitter. This has the advantage that the thawing process of liquid in the interior is uneven, as contaminated areas lead to inhomogeneities in the heat flow. Another advantage of the grip guard is that it reduces the volume of liquid in the filter element or the volume of liquid in the housing of the liquid filter, in which the filter element can be arranged. This means that less heating energy is required when thawing frozen liquids or keeping liquids liquid at low outside temperatures. This makes it advantageous to use a smaller heating element and also reduces fuel consumption (low CO2 footprint). Another advantage is that the volume of the compensation element can also be reduced due to the volume taken up by the grip guard, thereby also reducing the size of the compensation element. This has the advantage of reducing the amount of material used and therefore making production more cost-effective. This is because the size or volume of the compensation element is typically adapted to the volume of liquid in the filter element—this volume is reduced by the grip guard.

For example, the second opening has a diameter of at least 1.5 cm, preferably at least 2 cm. For example, the diameter is in the range between 1.5 cm and 7 cm, preferably in a range between 1.8 cm and 3 cm, e.g. the diameter can be 2.3 cm.

The grip guard can be formed by a plurality of ribs, for example. For example, the ribs extend radially outwards from a star point within the second opening. For example, they can be connected to an inner wall of the second opening. For example, the maximum distance between adjacent ribs is at most 1 cm, preferably at most 0.75 cm. For example, the distance is 0.85 cm. The ribs can, for example, have an angle in the range between 5° and 45°, preferably between 10° and 30°, with respect to the radial direction. For example, the angle is between 23 degrees and 26 degrees, e.g. 24.5 degrees.

The proposed diameters, distances and angles reduce the risk of a finger or part of a finger reaching the inner side of the filter medium even if the grip guard is partially overcome. The filtered side of the filter element is often located on the inner side of the filter medium. The angle can also allow the compensation element to be made longer. The second opening can, for example, also be located in a second connecting piece, which is arranged around the second opening of the second end cap. Such a second nozzle can have a length of at least 0.5 cm, e.g. a length in the range of 1.5 cm to 2.5 cm, for example 1.5 cm.

This further increases the grip guard, as the distance from the front side of the second nozzle to the inner side of the filter medium is increased. Another advantage is that the compensation element can be made longer and thus provide a larger compensation volume.

The design of a star point, from which ribs extend radially outwards, can also advantageously result in a simpler and more cost-effective production of the second end cap and thus of the filter element. This is because if this is produced in an injection molding process, e.g. from a glass fiber-filled plastic, a single injection point (e.g. in the star point or one of the ribs) can be sufficient to produce a low-distortion second end cap. This is otherwise not easily possible with an end cap with a second opening of a certain size without a star point and/or ribs. Several injection points are otherwise required here. For example, the second end cap can be made of plastic. It can, for example, have or be made of unfilled polypropylene (PP) or polyamide (PA) or hard polyethylene (HDPE (abbreviation for “high density polyethylene”)) or have or be made of a glass fiber-filled plastic, e.g. PE, PA (e.g. PA66), HDPE, etc. These can be thermoplastics and/or thermosetting plastics. The compensation element may, for example, comprise ethylene propylene diene rubber (EPDM) or hydrogenated acrylonitrile butadiene rubber (HNBR), e.g. for the most part or be made of it. The cover and/or a housing of the liquid filter can be made of PA, PA6, PA66, polyphthalamide (PPA), for example, or be made of these materials (with or without glass fiber filling).

According to a second aspect of the invention, a filter element as described above is proposed for use in a DENOX liquid filter.

This results in a particularly secure, durable and maintenance-friendly external and/or internal seal. Another advantage is that this enables particularly energy-efficient operation of such a liquid filter by means of the filter element. The thawing of frozen liquid or maintaining the liquid state of the liquid can therefore be particularly energy-efficient.

According to a third aspect of the invention, a liquid filter is proposed. According to a third aspect of the invention, a liquid filter is proposed. The liquid filter has a housing with a cover and a housing interior. The liquid filter also has an inlet and an outlet. Furthermore, the liquid filter has a filter element as described above, wherein the filter element is arranged in the interior of the housing.

This provides a particularly easy-to-maintain liquid filter with a safe, reliable and durable external and/or internal seal. Another advantage is that a particularly energy-efficient liquid filter is provided.

### BRIEF DESCRIPTION OF THE DRAWINGS

The following is shown in the images:

FIG. 1 a schematic longitudinal section through a liquid filter with a filter element according to the prior art;

FIG. 2 a schematic longitudinal section through a liquid filter with a filter element according to the invention;

FIG. 3 a schematic longitudinal section through the compensation element and parts of the cover from FIG. 2

FIG. 4 a schematic longitudinal section in which the embodiment according to FIG. 2 is shown on the left-hand side and the embodiment from the prior art according to FIG. 1 is shown on the right-hand side.

### DETAILED DESCRIPTION

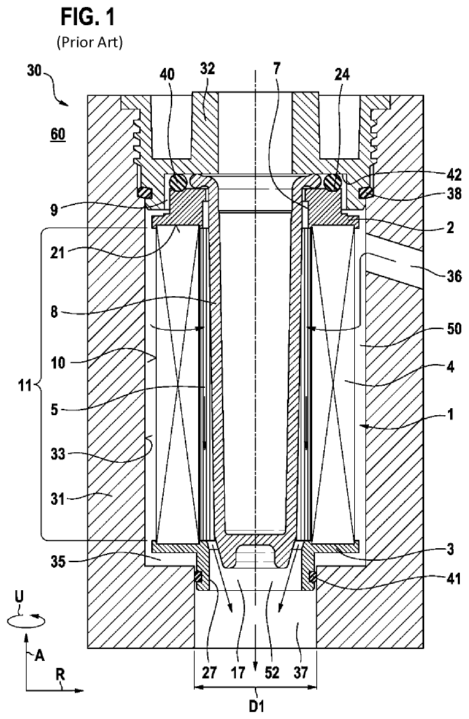

FIG. 1 shows a schematic longitudinal section through a liquid filter 30 of the prior art. The liquid filter 30 has a housing 31 with a cover 32. The housing 31 is here exemplarily cup-shaped with a housing interior 35. It also has an inlet 36 for unfiltered liquid, which is located in the liquid filter 30 on an unfiltered side 50, and an outlet 37 for filtered liquid, which is located in the liquid filter on a filtered side 52. The liquid filter 30 also has a filter element 1, wherein the filter element 1 is arranged in the housing interior 35. It is installed parallel to an axial direction A (here: against the axial direction A) in the housing interior 35, e.g. plugged in or screwed in or the like. The filter element 1 has a first end cap 2 facing the cover 32 and a second end cap 3 facing away from the cover 32. It also has a filter medium 4 with a hollow interior 5, wherein the filter medium 4 is arranged along the axial direction A between the first end cap 2 and the second end cap 3. The first end cap 2 has a first opening 7. An elastically reversible compensation element 8 is inserted into the interior 5, which projects from a cover-side exterior 9 of the filter element 1 through the first opening 7 into the interior 5. Sealing of the housing interior 35 against an external environment 60 of the liquid filter 30 is effected here by a cover sealing means 38 arranged on the cover 32 and over the outer circumference, which is pressed against a housing wall 33 of the housing 31. This seal can be referred to as an external seal. A so-called internal seal, which prevents the passage of uncleaned fluid on the unfiltered side 50 to the filtered side 52 without passing through the filter medium 4, is ensured here by a first end cap sealing means 40, which is arranged on a front side of the first end cap 2 and seals against the cover 32 (axial seal or sealing direction), and by a second end cap sealing means 41, which is arranged on the second end cap 3 and seals it against the housing wall 33 of the housing 31.

It can be clearly seen that the sealing effect of the first end cap sealing means 40 is dependent on the contact pressure or the pressure of the cover 32 on the first end cap sealing means 40. Furthermore, the first end cap sealing means 40 is arranged very close to the external environment 60 and is only separated from the external environment by the cover 32, with which it is in direct contact. The first end cap sealing means 40 is therefore exposed to large temperature fluctuations and can also be exposed to very large temperature gradients. Similarly, the cover sealing means is also arranged close to the external environment 60 and is only separated from the external environment 60 by the cover 32 with which it is in contact.

This means that the cover sealing means is also exposed to large temperature fluctuations and/or large temperature gradients.

Furthermore, it can be clearly seen that the uncleaned liquid passes between the housing wall 33 of the housing 31 and an outer side of the first end cap 2 into an exterior 9 on the cover side and fills it, wherein the exterior 9 on the cover side is arranged between a lower side 42 of the cover 32 and an upper side 24 (or outer side) of the first end cap 2 facing the cover 32. Liquid or fluid therefore flows from an outer filter volume 11 into the exterior 9 on the cover side. The filter outer volume 11 is to be regarded here as the volume which is formed between the housing wall 33 or the inner wall of the housing 31, an outer side 10 of the filter medium 4 and a lower side 21 (or inner side) of the first end cap 2 facing the filter medium 4.

A radial direction R extends perpendicular to the axial direction A. A direction of rotation U revolves around the axial direction A.

In the context of this application, the term “have” is to be understood synonymously with the term “comprise”, unless otherwise described.

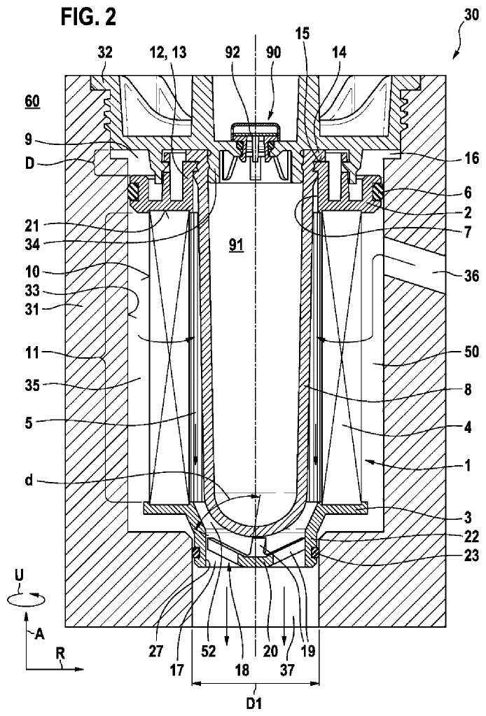

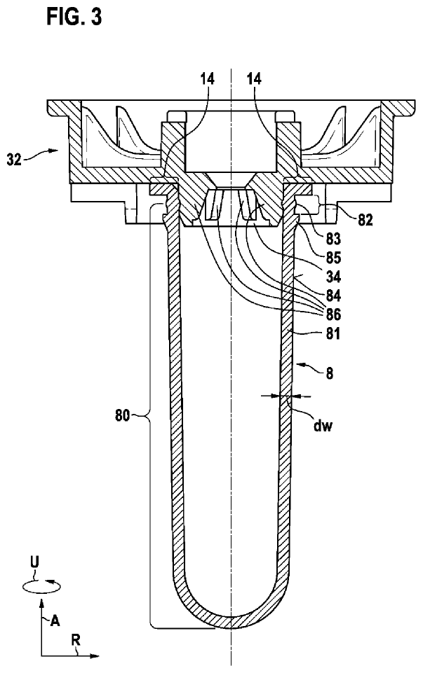

FIGS. 2 and 3 each show a longitudinal section of a liquid filter 30 and a compensation element 8 installed in a filter element 1 of the liquid filter 30. More details of the compensation element 8 are shown in FIG. 3 than in FIG. 2. The liquid filter 30 can be a DENOX liquid filter, for example. Such a DENOX liquid filter can be used in an SCR system, for example, to filter aqueous urea solutions for exhaust gas aftertreatment systems.

The liquid filter 30 again has a housing 31 with a cover 32 and a housing interior 35 as well as an inlet 36 and an outlet 37. It also has a filter element 1, which is arranged in the housing interior 35.

The filter element I can be arranged or is arranged parallel to an axial direction A (here: opposite the axial direction A) in the housing 31 or can be installed or is installed, e.g. can be plugged in or is plugged in, or can be inserted or screwed in. The filter element 1 here has a first end cap 2 facing the cover 32, a second end cap 3 facing away from the cover 32 and a filter medium 4 with a hollow interior 5. The filter medium 4 is arranged along the axial direction A between the first end cap 2 and the second end cap 3, wherein the first end cap 2 has a sealing means 6 over the outer circumference, wherein the first end cap 2 has a first opening 7, arranged here only centrally, for example. An elastically reversible compensation element 8 is arranged or can be arranged in the interior 5, which in a state arranged in the interior 5 (as shown here) projects from a cover-side exterior 9 of the filter element 1 through the first opening 7 into the interior 5. In the state shown here in the interior 5, the compensation element 8 seals the interior 5 in a fluid-tight manner against the passage of liquid from the interior 5 into the cover-side exterior 9 through the first opening 7. This creates the internal seal or gasket (on the cover side). This internal seal acts here along the radial direction R.

FIG. 3 shows a longitudinal section through the exemplary embodiment of the compensation element 8 and a part of the cover 32. The compensation element 8 has a body 80 with a wall 81 projecting into the interior 5 of the filter element 1 (see FIG. 2). In the area of the first opening 7 (see FIG. 2), the wall 81 has a thickened section 82 with a thickening 83. The seal between the compensation element 8 and the first opening 7 is formed here in the thickened section 82 as an example. The thickening 83 of the wall 81 in the thickened section 82 is formed both inwards and outwards when viewed in the radial direction R. The thickening 83 can, for example, be at least 1 mm, preferably at least 2 mm, in particular compared to the average wall thickness dW of the wall 81, which is shown as an example in the lower part of the body 80.

It can be clearly seen that the compensation element 8 in this exemplary embodiment has a latching lug 85 on one or on its outer side 84, which in this example can completely encircle the compensation element 8, viewed along the direction of rotation U. In this example, the compensation element 8 also has a radial section 14 that is spaced apart from the latching lug 85 in axial direction A and extends radially outwards. In this example, the radial section 14 is also designed to completely encircle the compensation element 8 along the direction of rotation U. Looking at FIGS. 2 and 3 together, it can be seen that the compensation element 8 is held in the first opening 7 by means of the latching lug 85 and the radial section 14. Here, for example, it is buttoned into the first opening. For this purpose, an edge 25 of the first opening or of the end cap element 12 or of the first connecting piece 13 is bent radially inwards and is arranged between the latching lug 85 and the radial section 14 when viewed in axial direction A. The compensation element 8 is thus held or buttoned into the first opening 7 (at least along the axial direction A). Furthermore, it can be seen that the thickened section 82 is arranged between the latching lug 85 and the radial section 14 when viewed in axial direction A.

The collar element 34 projecting from the cover 32 in axial direction A has reinforcing ribs 86. In the exemplary embodiment shown here, the compensation element 8 in the thickened section 82 is not merely in contact with the edge 25 of the first opening 7. In this example only, it is additionally pressed against the edge 25 of the first opening 7 by the collar element 34, which engages in the compensation element interior 91. This advantageously further improves the sealing effect of the compensation element 8 with respect to the first opening 7. In this way, for example, temperature-related volume changes of the compensation element 8 are advantageously compensated or become irrelevant due to the interference fit of the compensation element 8 between the edge 25 of the first opening 7 and the collar element 34. The sealing effect of the compensation element 8 with respect to the first opening 7 (internal seal) is a sealing effect acting in the radial direction R. In this embodiment, the cover 32 is at least slightly involved in the sealing effect (through the collar element 34). However, the strength or force (parallel to the axial direction A) with which the cover 32 is fastened in the housing 31, for example the torque (which ultimately causes an axial displacement of the cover 32 in the case of a screw connection), has little or no influence on the sealing effect. In principle, it is also conceivable that the compensation element 8 in the thickened section 82 has a reinforcing structure in its compensation element interior 91 (see FIG. 2) which extends through the compensation element interior 91 and makes the cooperation of the cover 32 unnecessary. For example, it can be at least one, e.g. spoke-shaped, clamping rib or a clamping ring or the like, wherein these elements can take over the effect of the collar element 34. These elements can be (subsequently) inserted into the compensation element 8 or connected to it in one piece.

The external seal, which is effected by the sealing means 6 on the first end cap 2, also acts in radial direction R against the housing wall 33. Here too, the cover 32 or a defined contact pressure, a defined contact force or a defined torque of the cover 32 is not required to produce the sealing effect.

The sealing means 6 is designed to seal the filter outer volume 11 against the cover-side exterior 9 when the filter element 1 is installed in the housing 31 as shown. The filter outer volume 11 is to be regarded here as the volume which is formed between the housing wall 33 or the inner wall of the housing 31, an outer side 10 of the filter medium 4 and a lower side 21 (or inner side) of the first end cap 2 facing the filter medium 4. As already explained above, the sealing means 6 thus ensures the external seal or sealing of the liquid filter 30. In the embodiment example shown here, the sealing means 6 is designed as a radial seal. A direct contribution of the cover 32 or an axial force applied by the cover 32 is not decisive for the sealing effect here. Inserting the filter element 1 into the housing 31 already establishes the external seal.

In this way, the installation of the cover 32 on the housing 31 is advantageously much less fault-tolerant with regard to the external seal and with regard to the internal seal, for example with regard to tilting of the cover 32 and/or too high or too low a torque in the case of a screwable cover 32. Further advantageously, in this way the sealing sections for the external seal and also for the internal seal are further away from the cover-side external environment 60, wherein this cover-side external environment 60 usually is particularly exposed to cold attack from the outside. This can advantageously reduce the amplitude and/or frequency of temperature fluctuations. Furthermore, the temperature gradient along the respective seals (sealing means or compensation element) can be reduced.

Furthermore, the arrangement of the sealing means 6 and the sealing arrangement of the compensation element 8 in the first opening 7 effectively prevents the passage of liquid into the exterior 9 on the cover side, which delays the freezing of the liquid or accelerates the thawing process during thawing and allows it to take place with less energy.

In the illustrated embodiment example, the sealing of the cover-side exterior 9 by means of the compensation element 8 and the sealing means 6 is designed or configured in such a way that the cover 32 is not in direct contact with the liquid at any point.

In the illustrated embodiment example, it is merely provided by way of example that an end cap element 12 projecting in axial direction A towards the cover 32 is formed on the first end cap 2. The end cap element 12 is exemplarily designed here as a first nozzle 13. The compensation element 8 has a radial section 14 running in the radial direction R perpendicular to the axial direction A. The radial section 14 can, for example, be clamped between a front side 15 of the end cap element 12 facing the cover 32 and the cover 32 when viewed in axial direction A. This can, for example, create a first sealing section that creates an axial seal A, which creates a redundancy to the radial seal and thus further improves the internal seal. The first sealing section can prevent the passage of filtered fluid on the filtered side 52 to the unfiltered fluid on the unfiltered side 50 through the first opening 7 into the exterior 9. The sealing effect can be adjusted, for example, by the contact pressure of the cover against the end cap element 12.

Preferably, as has already been explained above, it is provided here by way of example that the compensation element 8, viewed in the radial direction R, is clamped between the end cap element 12 and the collar element 34 projecting from the cover 32 into the first opening 7, which in this case is formed integrally with the cover 32 or is connected to the cover 32 (wherein the collar element 34-as has been explained above—is not an essential element). This results in a second sealing section which prevents the passage of filtered fluid on the filtered side 52 to the unfiltered fluid on the unfiltered side 50 through the first opening 7 into the cover-side exterior 9 (in the form of a largely radial seal which is no longer dependent on the pressure of the cover 32—such a seal can be the preferred seal). The sealing of the first opening 7 described in this way thus prevents fluid (in this embodiment example, filtered fluid) from entering the cover-side exterior 9.

If a surface of the first end cap 2 is considered without the first opening 7, the sealing means 6 as well as the sealing of the first opening 7 by means of the compensation element 8 ensures that at least 50% of this surface of the first end cap 2, preferably at least 70% of this surface is spaced from the cover 32 by a gap 16. This gap 16 is preferably filled with air in the specified surface area (at least 50% or at least 70%). It is particularly advantageous if the gap 16 is filled exclusively with air. In this way, the outflow of heat from the liquid filter in the direction of the cover 32 is advantageously further reduced and the energy efficiency during heating is further increased.

Viewed along the axial direction A, the gap 16 has an average thickness D (only an example of how large the average thickness D could be is shown here) of at least 1 mm, preferably at least 2 mm. This provides particularly good thermal insulation against the cold on the cover 32 and increases energy efficiency during heating.

The sealing means 6 can be designed as an O-ring or a sealing cord, for example.

The second end cap 3 has a second opening 17 for liquid to flow through. This results in a particularly simple, low-resistance and low-turbulence flow (in this case an outflow) of the liquid from the interior 5 of the filter element 1 (or, conversely, an inflow into the interior 5). A second connecting piece 22 is formed around the second opening 17, which projects from the second end cap 3, for example by at least 0.5 cm, preferably at least 1 cm and most preferably at least 1.5 cm, e.g. in a range between 1.5 cm and 2.5 cm, e.g. by 1.5 cm. A nozzle sealing means 23 is arranged on the outer side of the second nozzle 22, which in this case seals the unfiltered side 50 from the filtered side 52 (internal seal, side facing away from the cover), which in this example is located inside the second nozzle 22. A grip guard 18 is arranged in the second opening 17, in particular in the second connection piece 22, which is designed to prevent a finger from penetrating into the interior 5 through the second opening 17. The second opening 17 has, for example, a diameter Dl of at least 1.5 cm, preferably at least 2 cm, e.g. a diameter Dl of 2.3 cm. As shown here, the grip guard 18 can, for example, be formed by a plurality of ribs 19. These can merely extend, for example as shown here, from a star point 20 within the second opening 17 in the radial direction R outwards and be connected, for example, to an inner wall 27 of the second opening 17. A single, continuous rib 19 can also be regarded as two ribs 19 from the star point view, which extend away from each other from a star point 20. For example, a maximum distance d between adjacent ribs 19 is at most 1 cm, preferably at most 0.75 cm, e.g. the distance d is 0.85 cm. The ribs 19 can be arranged with respect to the radial direction R at an angle in the range between 5° and 45°, preferably between 10° and 30°. For example, the angle is between 23 degrees and 26 degrees, e.g. 24.5 degrees. In this way, the introduction or penetration of dirt on the inner side of the filter medium 4 is advantageously prevented, which can lead to inhomogeneities in the heat distribution in the interior and would therefore impair energy efficiency.

In contrast to the liquid filter 30 in FIG. 1, the internal seal in the liquid filter shown here is ensured by the sealing of the first opening 7 by means of the compensation element 8 and the nozzle sealing means 23—this also creates an external seal on the filtered side 52. The external seal (at least with respect to the unfiltered side 50) is effected by the sealing means 6 arranged on the first end cap 2, as a result of which the cover sealing means 38 arranged on the cover 32 of FIG. 1 can be omitted-however, this can alternatively still be provided in principle as a redundant sealing means for the external seal.

In a particularly advantageous embodiment, the cover 32 is captively coupled or connected to the filter element 1 after the compensation element 8 has been installed in the interior 5 of the filter element 1, wherein the cover 32 and the filter element Ican initially be separately manufactured parts which are then connected to one another. This connection can be made, for example, after inserting the compensation element 8 into the interior 5 of the filter element 1. A cover-filter element system (as a captive coupled component) can thus be designed. This captive connection is particularly advantageous because it cannot be released non-destructively or can only be released with great effort and special tools. In this way, a pre-assembled system (component) is provided consisting of cover 32, compensation element 8 and filter element 1, in which the correct installation of the compensation element 8 in the interior 5 is ensured and contamination of the inner side of the filter medium 4 is excluded, as the installation can be carried out reliably in the manner of a pre-assembly in a clean environment. The formation of the gap 16 and its correct thickness can also be advantageously achieved in this way.

In order to further improve energy efficiency, it is merely provided here, for example, that the compensation element 8 is separated from direct (convective) contact with the external environment 60 on its side facing the cover 32 by a cap element 90, here in the form of a sealing cap. Here, the sealing cap 90 is arranged in the cover 32 and has, by way of example, a semi-permeable membrane 92, through which a (slow) exchange of air with a compensation element interior 91 is possible, but which prevents dirt, grime and moisture from entering the compensation element interior 91. This can also advantageously reduce the amplitude and frequency of temperature fluctuations and/or a temperature gradient, e.g. on the internal seal (but also on the external seal).

In principle, for example, it can be provided that the compensation element interior 91 of the compensation element 8 is separated from the external environment 60 of the liquid filter 1 by separating means in such a way that a (slow) exchange of air can take place with the external environment 60 when the compensation element 8 is compressed or decompressed However, at the same time a (rapid) air convection or an open exchange of air between the compensation element interior 91 and the external environment 60 is prevented and therefore no or only little heat is lost into the external environment or no cold bridge into the interior 5 of the filter element 1 is formed by the compensation element 8.

For this purpose, the only separating means that can be provided are, for example: a membrane, in particular a membrane 92 which is permeable to gases but impermeable to moisture (as presented here), a labyrinth seal or an interdigital structure at least in a section of the compensation element 8, in which projections project from two or more inner sides into the compensation element interior 91, which are offset from one another along the axial direction A, so that gas exchange with the external environment 60 is suppressed or slowed down. Other release agents with an equivalent effect are also conceivable. Furthermore, it is conceivable that the compensation element 8 is manufactured and/or filled from a compressible material, e.g. a foam material, so that the compensation element interior 91 is filled with this material. In this way, a cold bridge extending from the external environment 60 into the interior 5 of the filter element 1 is prevented, as non-circulating air or air not subject to convection has a very low thermal conductivity of approx. 0.026 W/K*m.

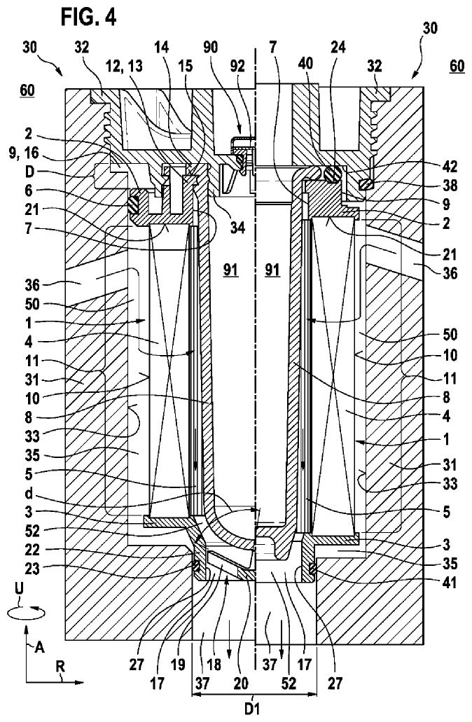

FIG. 4 shows a schematic longitudinal section, in which the liquid filter 30 and the filter element 1 from FIG. 2 are shown on the left-hand side (in a mirrored view: the inlet 36 is now on the left-hand side) and the liquid filter 30 and the filter element 1 from FIG. 1 are shown on the right-hand side.

FIG. 4 clearly shows the differences between the two filter elements 1 and how liquid is prevented from entering the exterior 9 on the cover side in the embodiment shown in FIG. 2.

1. A filterFilter element configured for filtering a liquid,
wherein the filter element (1) is configured for installation parallel to an axial direction (A) in a housing (31) with a cover (32), the filter element (1) having:
a first end cap (2) facing the cover (32),
a second end cap (3) facing away from the cover (32),
a filter medium (4) with a hollow interior (5),
wherein the filter medium (4) is arranged along the axial direction (A) between the first end cap (2) and the second end cap (3), wherein a radial direction (R) extends perpendicular to the axial direction (A),
wherein the first end cap (2) has a sealing means (6) over an outer circumference,
wherein the first end cap (2) has a first opening (7), i
wherein an elastically reversible compensation element (8) can be arranged in the interior (5),
wherein the compensation element (8), in a state arranged in the interior (5), projects from a cover-side exterior (9) of the filter element (1) through the first opening (7) into the interior (5) and seals the interior (5) in a fluid-tight manner against a passage of liquid from the interior (5) into the cover-side exterior (9) through the first opening (7), and
wherein the sealing means (6) is configured to seal a filter outer volume (11) located between a housing wall (33), an outer side (10) of the filter medium (4) and a lower side (21) of the first end cap (2) facing the filter medium (4) against the cover-side exterior (9) in a state of the filter element (1) installed in the housing (31).

2. The filter element according to claim 1,
wherein the sealing means (6) is configured for sealing along the radial direction (R),
wherein the sealing of the first opening (7) by the compensation element (8) is deigned configured as a seal along the radial direction (R).

3. The filter element according to claim 1,
wherein the compensation element (8) has a body (80) with a wall (81) projecting into the interior (5),
wherein the wall (81) has a thickened section (82) with a thickening (83) in a region of the first opening (7),
wherein a seal between the compensation element (8) and the first opening (7) is formed in the thickened section (82).

4. The filter element according to claim 3the preceding claim,
wherein the thickening (83) of the wall (81) in the thickened section (82) is formed both inwardly and outwardly when viewed in the radial direction (R).

5. The filter element according to claim 3,
wherein the thickening (83) is at least 1 mm, preferably at least 2 mm thicker than an average wall thickness (dW) of the wall (81).

6. The filter element according to claim 3,
wherein the compensation element (8) has a, latching lug (85) on an outer side (84),
wherein the compensation element (8) has a radial section (14) which is spaced from the latching lug (85) in the axial direction (A),
wherein the compensation element (8) is held, in the first opening (7) by the latching lug (85) and the radial section (14),
wherein the thickened section (82) is arranged between the latching lug (85) and the radial section (14) when viewed in the axial direction (A).

7. The filter element according to claim 1,
wherein, in a state of the filter element (1) installed in the housing (32), the compensation element (8) is clamped between the first opening and a collar element (34) projecting from the cover (32) into the first opening (7) when viewed in the radial direction (R).

8. The filter element according to claim 7,
wherein an end cap element (12) projecting in the axial direction (A) towards the cover (32), is formed on the first end cap (2),
wherein, in a state of the filter element (1) installed in the housing (32), the compensation element (8) is clamped between the end cap element (12) and the collar element (34) when viewed in the radial direction (R).

9. The filter element according to claim 1,
wherein the sealing means (6) is configured as an O-ring or as a sealing cord.

10. The filter element according to claim 9,
wherein the sealing of the cover-side exterior (9) by means of the compensation element (8) and the sealing means (6) is configured in such a way that the cover (32) is not in direct contact with the liquid at any point.

11. The filter element according to claim 1,
wherein, in a state of the filter element (1) installed in the housing (31), the first end cap (2) is spaced apart from the cover (32) by a gap (16), over at least 50% of its area excluding the first opening (7).

12. The filter element according to claim 11,
wherein the gap (16) along the axial direction (A) has an average thickness (D) of at least 1 mm.

13. The filter element according to claim 1, wherein the second end cap (3) has a second opening (17) for liquid to flow through,
wherein a grip guard (18) is arranged in the second opening (17), which is configured to prevent a finger from penetrating into the interior (5) through the second opening (17),
wherein the second opening (17) has a diameter (Dl) of at least 1.5 cm, preferably of at least 2 cm,
wherein the grip guard (18) is formed by a plurality of ribs (19),
wherein the ribs (19), extend outwards in the radial direction (R), and
wherein a maximum distance (d) between adjacent ribs is at most 1 cm.

14. The filter element according to claim 1 for use in a DENOX liquid filter.

15. A liquid filter,
the liquid filter (30) having:
a housing (31) with a cover (32), with a housing interior (35) and with an inlet (36) and an outlet (37),
a filter element (1) according to claim 1,
wherein the filter element (1) is arranged in the housing interior (35).

16. The filter element according to claim 5, wherein the thickening (83) is at least 2 mm, thicker than the average wall thickness (dW) of the wall (81).

17. The filter element according to claim 6, wherein the latching lug (85) is circumferential on the outer side (84),
wherein the radial section (14) is a circumferential radial section (14) which extends radially outwards, and
wherein the compensation element (8) is buttoned in the first opening (7) by the latching lug (85) and the radial section (14).

18. The filter element according to claim 11, wherein, in a state of the filter element (1) installed in the housing (31), the first end cap (2) is spaced apart from the cover (32) by a gap (16) over at least 70% of its area excluding the first opening (7).

19. The filter element according to claim 12, wherein the gap (16) along the axial direction (A) has an average thickness (D) of at least 2 mm.

20. The filter element according to claim 13,
wherein the second opening (17) has a diameter (Dl) of at least 2 cm,
wherein the ribs (19) start from a star point (20) within the second opening (17) and are connected to an inner wall (27) of the second opening (17), and
wherein a maximum distance (d) between adjacent ribs is at most 0.75 cm.
